(19) United States
(12) Patent Application Publication
(10) Pub. No.: US 2006/0058019 A1
(43) Pub. Date: Mar. 16, 2006

(54) Method and system for dynamically modifying the appearance of browser screens on a client device

(76) Inventors: Wesley T. Chan, Mountain view, CA (US); Shioupyn Shen, Mountain View, CA (US)

Correspondence Address: Marina Portnova;BLAKELY, SOKOLOFF, TAYLOR & ZAFMAN LLP, Seventh Floor, 12400 Wilshire Boulevard, Los Angeles, CA, 90025, US

(21) Appl. No.: 10/942,610

(22) Filed: Sep. 15, 2004

(51) Int. Cl. H04Q 7/20

(52) U.S. Cl. 455/422.1; 455/41.2

(57) ABSTRACT

In one embodiment, a connection of a client device to a wireless access point is identified. Further, the appearance of a screen presented on the client device is modified to reflect the brand associated with a provider of the wireless access point.

### FIELD OF INVENTION

The field of invention relates generally to wireless data communication, and more particularly, to dynamically modifying the appearance of browser screens on a client device.

### BACKGROUND

Mobile computer users are able to enjoy wireless Internet access at various wireless access points (WAPs), commonly referred to as WiFi access points. The WiFi access points are wireless access points that are compatible with IEEE 802.11, as certified by the Wireless Fidelity (WiFi) Alliance.

Usually, WiFi operators deploy WiFi access points at high traffic locations to meet the need of mobile users. The cost of WiFi Internet access is relatively high because WiFi operators need to recoup their investment in deployment and maintenance of access points and make some profits.

The relative high price for an end-user to access a WiFi access point is typically not a problem for executives or road warriors. However, many casual mobile computer users may be deterred from using WiFi Internet access because they typically only need it once in a while and are reluctant to pay a premium price for their occasional needs.

As a result, the gap between what WiFi operators charge and what casual mobile users are typically willing to pay, is relatively significant. Therefore, WiFi Internet access as an industry has experienced a rather slow start.

### SUMMARY

In one embodiment, a connection of a client device to a wireless access point is identified. Further, the appearance of a screen presented on the client device is modified to reflect the bran associated with a provider of the access point.

### BRIEF DESCRIPTION OF THE DRAWINGS

The present invention is illustrated by way of example and not limitation in the figures of the accompanying drawings, in which like references indicate similar elements and in which:

FIG. 1 presents a diagram illustrating an overview of one embodiment of the present invention;

FIG. 2 is a block diagram illustrating an architecture in which one embodiment of the present invention may be implemented;

FIG. 3 is a block diagram of one embodiment of a client co-branding module;

FIG. 4 is a block diagram of one embodiment of a server co-branding module;

FIG. 5 presents a flow diagram of one embodiment of a method for a client-based modification of the appearance of browser screens on a client device;

FIG. 6 is a flow diagram of one embodiment of a method for a server-based modification of the appearance of browser screens on a client device; and

FIG. 7 is a block diagram of one embodiment of a computer system.

### DETAILED DESCRIPTION

Overview of One Embodiment

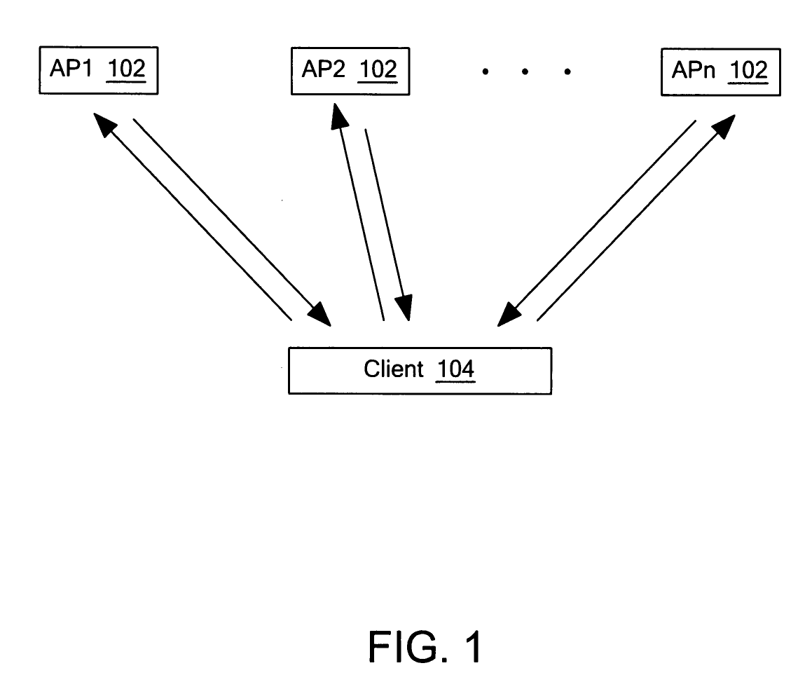

A method and system for dynamically modifying the appearance a screen presented on a client device is described. FIG. 1 presents a diagram illustrating an overview of one embodiment of the present invention.

Referring to FIG. 1, access points 102 (AP1 through APn) can provide network access (e.g., Internet access) to various client devices, including a client 104. In one embodiment, the access points 102 are wireless access points that are compatible with IEEE 802.11, as certified by the Wireless Fidelity (WiFi) Alliance. The client 104 may be a mobile device such as a portable computer, a personal digital assistant (PDA), a mobile phone, etc. The client 104 may be coupled to the access points 102 via one or more wireless networks (e.g., wireless local area networks (WLANs)).

In order to receive access to the Internet, the client 104 connects to one of the access points 102 (e.g., AP1). Once the client 104 connects to AP1, the appearance of a screen presented on the client device 104 is modified to reflect the brand of the provider of AP1. In one embodiment, the screen presented on the client device 104 includes a browser window, and the modification of the screen's appearance affects features displayed in the browser window. That is, the features displayed in the browser window are modified with features reflecting the brand of the AP1 provider. These features may include, for example, a toolbar, a tool palate, a screen background, logos, etc.

In one embodiment, the modification of the screen's appearance also affects advertisements displayed on the client device. In particular, once the client device 104 connects to AP1, the user of the client device 104 is presented with the advertisements relating to the AP1 provider. The advertisements may be displayed, for example, in a toolbar, within (or to the side of) the content displayed on the client's screen, etc.

When the client device 104 moves beyond the area covered by AP1, the client device 104 may switch to a different access point (e.g., AP2). Once the client device 104 connects to AP2, the features reflecting the brand of the AP1 provider are no longer displayed to the user. Instead, the appearance of the browser screens is modified to reflect the brand of the AP2 provider.

As a result of such a co-branding, providers of access points receive an additional opportunity to promote their business.

References throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

System Architecture

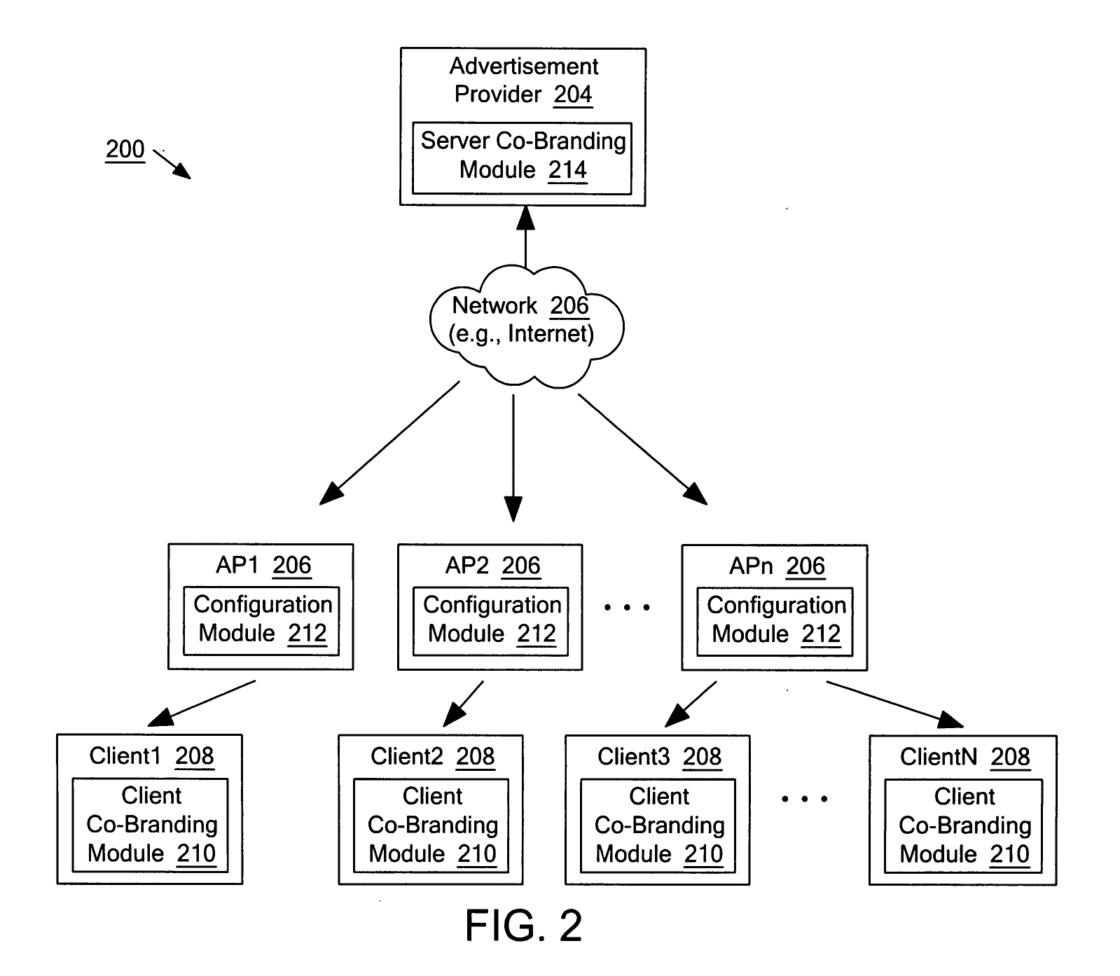

FIG. 2 is a block diagram illustrating an architecture 200 in which one embodiment of the present invention may be implemented. The architecture 200 includes multiple client devices 208 (client 1 through client N), multiple access points 206 (AP1 through APn), an advertisement provider 204, and a network 202, which may be, for example, the Internet.

The access points 206 are disparate wireless access points (WAPs) supplied by different providers to enable access to the network 202 for the clients 208. In one embodiment, traffic outgoing from, and incoming to, the access points 206 passes through the advertisement provider 204. The advertisement provider 204 is an entity distinct from the WAP providers that acts as a gateway by receiving the traffic outgoing from, and incoming to, the access points 206 and forwarding the received traffic to requested destinations. In one embodiment, the advertisement provider 204 collects advertisements from different advertisers and causes the advertisements to be presented to the users of client devices 208 when the users navigate the web. The collection and presentation of advertisements is described in more detail in the U.S. patent application entitled “Method and System to Provide Advertisements Based on Wireless Access Points”, Ser. No. ______, filed Sep. 14, 2004, which is hereby incorporated by reference.

The advertisement provider 204 may be a wireless Internet service provider (WISP), a virtual Internet service provider (VISP), an online service provider (OSP), or any other entity capable of providing the above-mentioned functionality.

As discussed above, the advertisement provider 204 may act as a gateway and receive all traffic outgoing from, and incoming to, the clients 208. In one embodiment, this is accomplished by the clients 208 either proxy through or establish a virtual private network (VPN) with the system of the advertisement provider 204. In alternative embodiments, alternative implementations may be used to cause network traffic to pass through the advertisement provider 204. For example, some alternative implementations include having the advertisement provider 204 provide its own access points, and/or providing a list of service set identifier-wired equivalent privacy (SSID-WEP) settings to be downloaded by the clients 208 to connect to any of the listed access points.

In one embodiment, the access points 206 provide network access to the clients 208 free of charge (or at a reduced price) in exchange to users' consent to receive ads. For example, the advertisements may be presented in a toolbar of a browser window displayed on the client's screen, within (or to the side of the content displayed on the client's screen, etc. In one embodiment, the advertisement provider 202 receives revenue from advertisers for advertisements selected by (or displayed to) the clients 208 and shares this revenue with the access points 206. As a result, the access point providers may cover the expenses of deploying and maintaining access points 206 and may recoup a profit, while providing network access to the clients 208 at a reduced price (or free of charge).

In one embodiment, while the clients 208 browse the web using the access points 206, the appearance of screens presented on the clients 208 reflects the brand of respective access point providers. In particular, the screens presented on the client 208 include features associated with the provider of a corresponding access point. These features may include, for example, a toolbar, a tool palate, a screen background, logos, etc. In one embodiment, the access point 206 includes a configuration module 212 that allows the access point provider to specify which features should be added to the screens presented to the user. Alternatively, the types of features are predetermined and cannot be modified by individual access point providers.

In one embodiment, the features associated with the access point provider are added to the content presented to the user on the client side. Specifically, each client 208 includes a client co-branding module 210 that is responsible for modifying the appearance of the screens presented to the user based on the access point currently providing network access for the client 208. In one embodiment, the client co-branding module 210 identifies a connection of the client 208 to a new access point, requests information about the features associated with the access point provider that need to be included in the browser screens presented to the user, receives the feature information, and stores the feature information locally. Then, when the client co-branding module 210 receives web content from the advertisement provider 206, it causes the web content to be displayed in a browser window with the features reflecting the brand of the access point provider.

In one embodiment, the client co-branding module 210 requests the feature information from the configuration module 212 of the access point 206. Alternatively, the client co-branding module 210 requests the feature information from a server co-branding module 214 residing on the advertisement provider system 206.

In an alternative embodiment, the features associated with the access point provider are added to the content presented to the user on the server side. Specifically, the system of the advertisement provider 206 includes a server co-branding module 214 that is responsible for modifying the appearance of screens presented to the user based on the access point currently providing network access for the client 208. In one embodiment, the server co-branding module 214 collects feature information from the access points 206 and stores the feature information in a database. Subsequently, when a client 208 connects to an access point 206, the server co-branding module 214 identifies this connection, retrieves feature information associated with the provider of the access point 206, adds the specified features to the web content requested by the client 208, and sends the result to the client 208 which displays it to the user. The addition of the features modifies the appearance of a screen presented to the user, causing it to reflect the brand of the access point provider.

In yet another embodiment, the features associated with the access point provider are added to the content presented to the user both on the server side and the client side. That is, the server co-branding module 214 may add a first set of features to the content presented to the user, and the client co-branding module 210 may add a second set of features to the content presented to the user. The first set of features may include, for example, the logos and advertisements reflecting the brand of the access point provider, and the second set of features may include, for example, the screen background, the toolbar and the tool palate reflecting the brand of the access point provider.

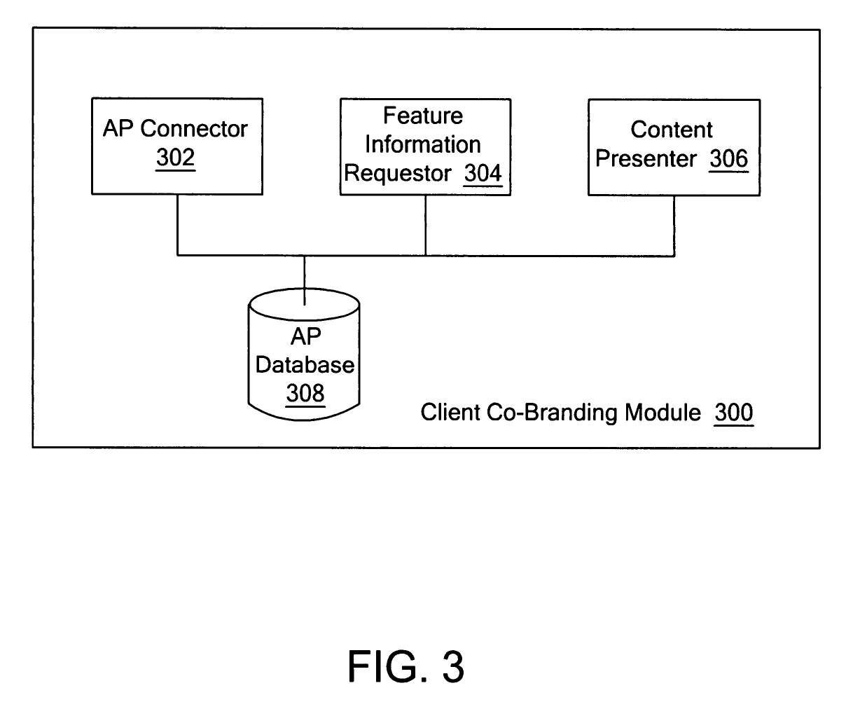

FIG. 3 is a block diagram of one embodiment of a client co-branding module 300. The client co-branding module 300 may include an access point connector 302, a feature information requestor 304, a content presenter 306, and an access point database 308.

The access point connector 302 is responsible for connecting to an access point to provide network access for a client device.

The feature information requestor 304 is responsible for requesting information about features associated with the brand of the access point provider, receiving the feature information, and storing the feature information in the access point database 308. The features associated with the brand of the access point provider may include, for example, a toolbar, a tool palate, a screen background, logos, etc. In one embodiment, the feature information requestor 304 requests the feature information from the access point. Alternatively, the feature information requestor 304 requests the feature information from the advertisement provider 206, which collects the feature information from various access points.

The content presenter 306 is responsible for receiving web content from the advertisement provider 206, and causing the web content to be displayed in a browser window with the features reflecting the brand of the access point provider. In one embodiment, the content presenter 306 cooperates with a browser application to present the web content with the features reflecting the brand of the access point provider in the browser window.

When the access point connector 302 switches to a new access point, the feature information requestor 304 requests and stores feature information of the new access point in the database 308, and the content presenter 306 dynamically (i.e., in real time) modifies the features associated with the previous access point provider that are displayed in the browser window with the features reflecting the brand of the provider of the new access point. Switching between access points is described in more detail in the U.S. patent application entitled “Method and System for Facilitating Automated Transitions Between Access Points”, Ser. No. ______, filed Sep. 14, 2004, which is hereby incorporated by reference.

In another embodiment, the content presenter 306 receives from the advertisement provider 206 web content with a first set of features (e.g., logos and advertisements) associated with the access point provider, adds a second set of features (e.g., a toolbar, screen background and tool palate), and causes the web content to be displayed in the browser window with the first and second sets of features.

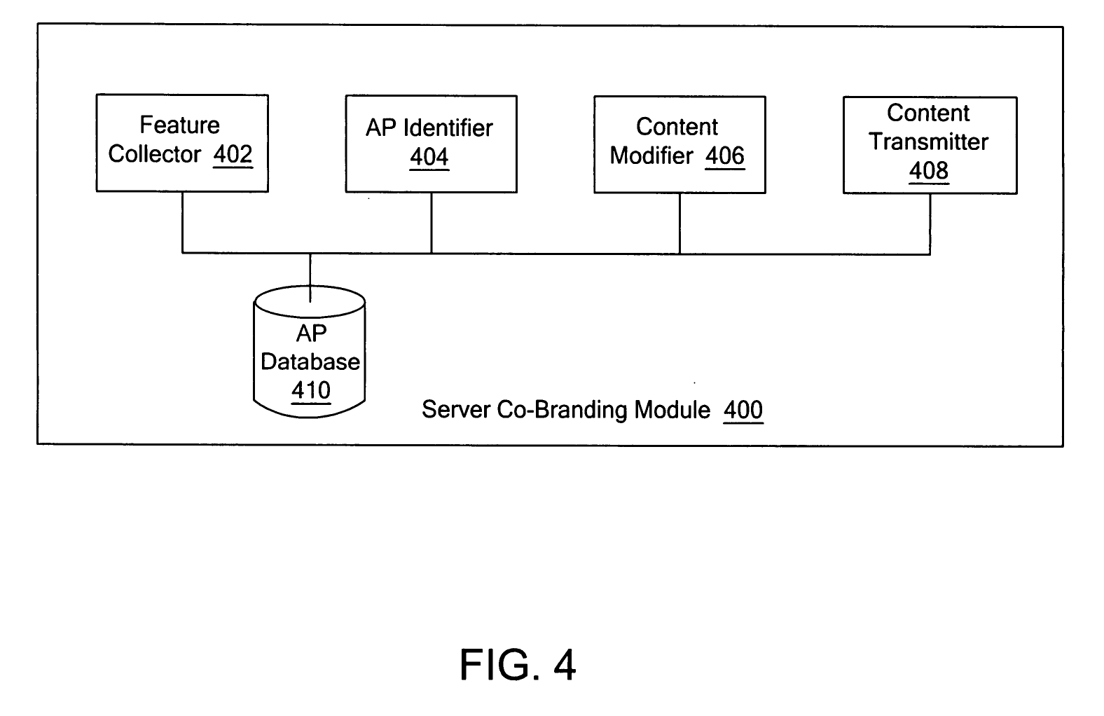

FIG. 4 is a block diagram of one embodiment of a server co-branding module 400. The server co-branding module 400 may include a feature collector 402, an access point identifier 404, a content modifier 406, a content transmitter 408, and an access point database 410.

The feature collector 402 is responsible for collecting feature information from various access points and storing the feature information in the access point database 410. The feature information specifies features reflecting the brand of an access point provider. As discussed above, the features may include, for example, a toolbar, a tool palate, a screen background, logos, etc.

The access point identifier 404 is responsible for identifying a connection of a client device to an access point. In one embodiment, the access point identifier 404 identifies the connection to the access point upon receiving an identifier of the access point from the client device connecting to the access point.

The content modifier 406 is responsible for receiving content requested by the client device from a content server, and adding the features reflecting the brand of the access point provider to the requested content. In one embodiment, the content modifier 406 also adds advertisements associated with the access point provider to the requested content.

The content transmitter 408 is responsible for sending the modified content produced by the content modifier 406 to the client device.

Description of Process

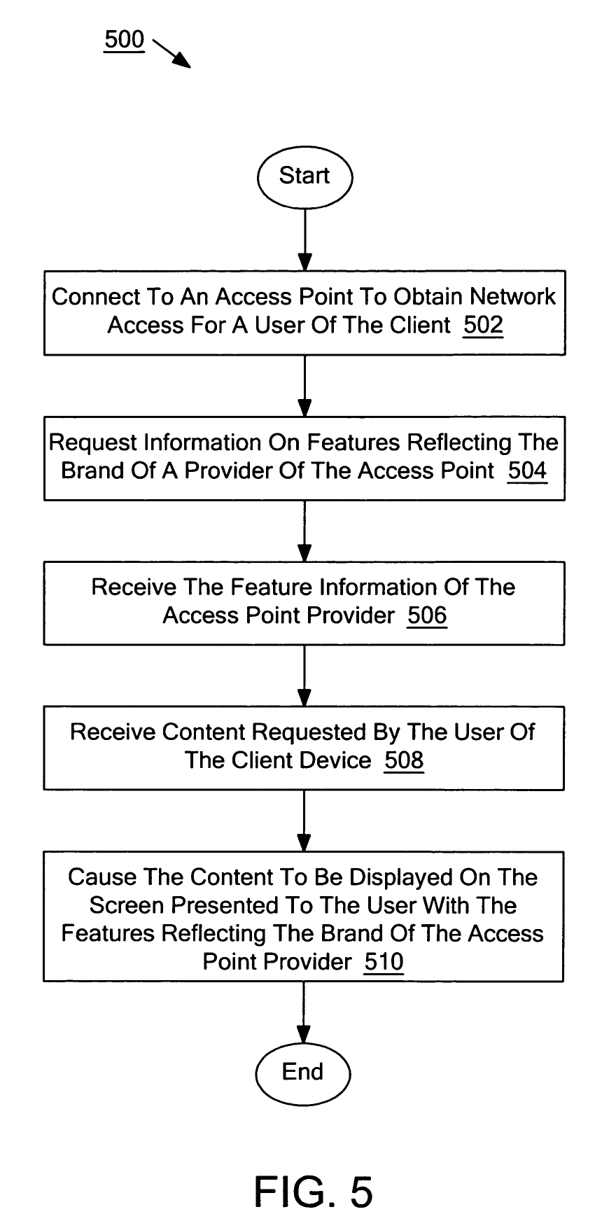

FIG. 5 presents a flow diagram of one embodiment of a method for a client-based modification of the appearance of browser screens on a client device. The method may be performed by processing logic, which may comprise hardware, software, or a combination of both. Processing logic may reside either in a client device, or partially or entirely in a separate device and/or system(s).

At block 502, processing logic connects to one of multiple disparate WAPs to obtain network access for a user of the client device.

At block 504, processing logic requests information on features reflecting the brand of a provider of the WAP. In one embodiment, processing logic may request the feature information from the WAP. Alternatively, processing logic may request the feature information for the WAP provider from another entity such as the advertisement provider 206.

At block 506, processing logic receives the feature information of the WAP.

At block 508, processing logic receives content requested by the user of the client device.

At block 510, processing logic causes the content to be displayed on the screen presented to the user with the features reflecting the brand of the WAP provider.

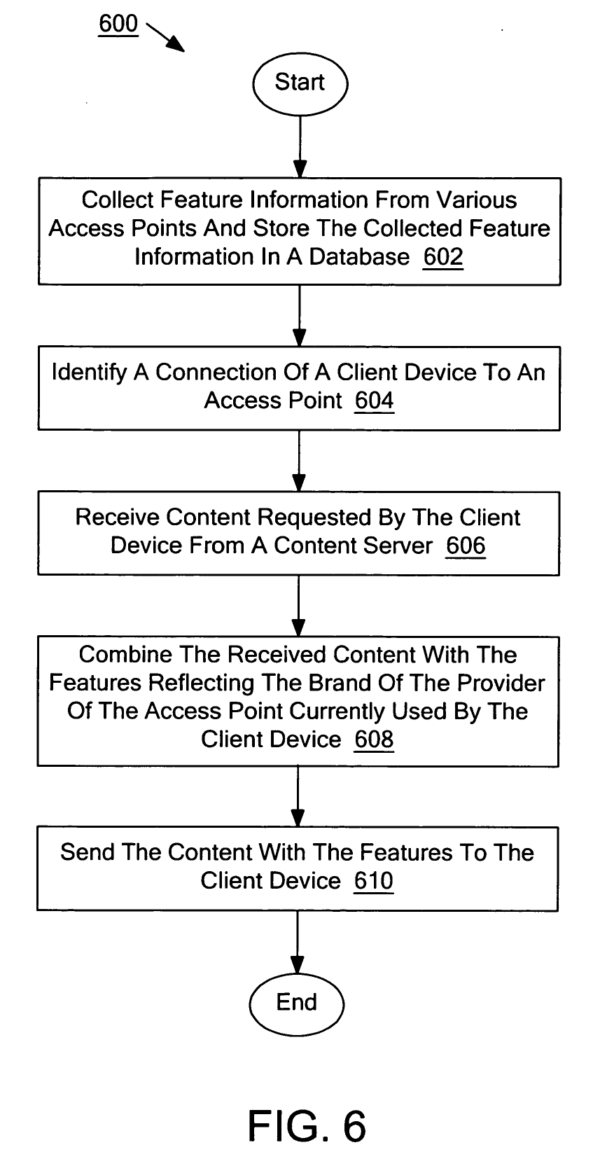

FIG. 6 presents a flow diagram of one embodiment of a method for a server-based modification of the appearance of browser screens on a client device. The method may be performed by processing logic, which may comprise hardware, software, or a combination of both. Processing logic may reside either on a server (e.g., an advertisement provider server), or partially or entirely in a separate device and/or system(s).

At block 602, processing logic collects feature information from various WAPs and stores the collected feature information in a database.

At block 604, processing logic identifies a connection of a client device to a WAP. In one embodiment, processing logic identifies the connection upon receiving an identifier of a new WAP from the client device.

At block 606, processing logic receives content requested by the client device from a content server.

At block 608, processing logic combines the received content with the features reflecting the brand of the provider of the WAP currently used by the client device.

At block 610, processing logic sends the content with the features to the client device.

Exemplary Computer System

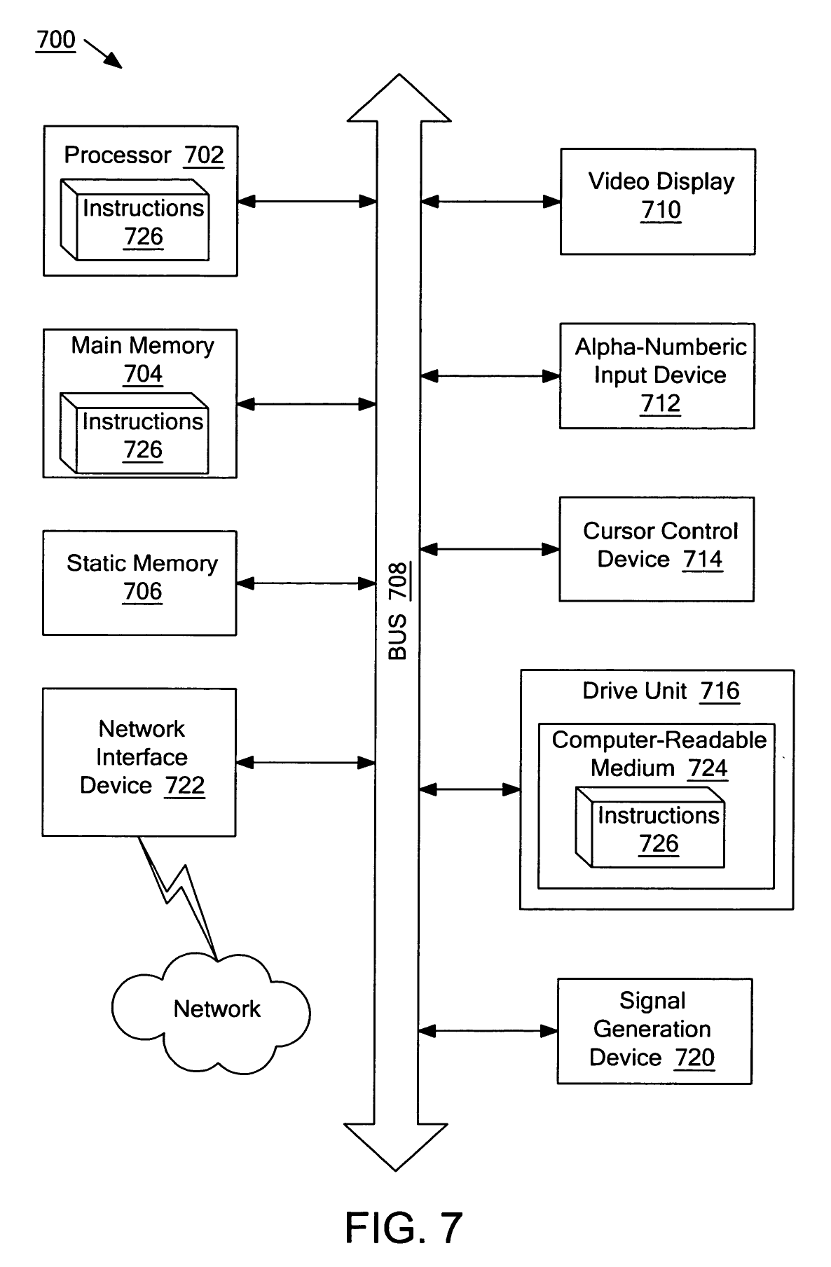

FIG. 7 shows a diagrammatic representation of machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

General Legal Statements

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method, comprising:
identifying a connection of a client device to a wireless access point; and
causing an appearance of a screen presented on the client device to be modified to reflect a brand associated with a provider of the wireless access point.

2. The method of claim 1 wherein causing the appearance of the screen presented on the client device to be modified comprises:
combining content to be displayed in a browser window with features associated with the brand of the provider of the wireless access point.

3. The method of claim 2 wherein the features comprise at least one of a toolbar, a tool palate, a background of the screen, and a logo of the provider of the wireless access point.

4. The method of claim 1 further comprising:
receiving data specifying the features associated with the brand of the provider of the wireless access point.

5. The method of claim 1 wherein identifying the connection of the client device to the wireless access point comprises:
receiving an identifier of the wireless access point.

6. The method of claim 1 wherein the wireless access point provides Wireless Fidelity (WiFi) Internet access to a user of the client device.

7. The method of claim 6 wherein the WiFi Internet access is provided to the user free of charge in exchange to a user consent to receive ads.

8. The method of claim 1 further comprising:
displaying advertisements relating to the provider of the wireless access point on the screen of the client device.

9. A method comprising:
displaying, in a browser window on a client device, features associated with a brand of a provider of a first wireless access point;
detecting that the client device has switched from the first wireless access point to a second wireless access point; and
dynamically modifying the features associated with the brand of the provider of the first wireless access point with features associated with a brand of a provider of the second wireless access point.

10. The method of claim 9 wherein the features comprise at least one of a toolbar, a tool palate, a background of the screen, and a logo of the provider of the wireless access point.

11. The method of claim 9 wherein each of the first and second wireless access points provides Wireless Fidelity (WiFi) Internet access to a user of the client device.

12. The method of claim 11 wherein the WiFi Internet access is provided to the user free of charge in exchange to a user consent to receive ads.

13. The method of claim 9 further comprising:
dynamically replacing in the browser window advertisements relating to the provider of the first wireless access point with advertisements relating to the provider of the second wireless access point.

14. An apparatus comprising:
an access point identifier to identify a connection of a client device to a wireless access point; and
a content modifier to cause an appearance of a screen presented on the client device to be modified to reflect a brand associated with a provider of the wireless access point.

15. An apparatus comprising:
means for identifying a connection of a client device to a wireless access point; and
means for causing an appearance of a screen presented on the client device to be modified to reflect a brand associated with a provider of the wireless access point.

16. An apparatus comprising:
a content presenter to display, in a browser window on a client device, features associated with a brand of a provider of a first wireless access point; and
an access point connector to detect that the client device has switched from the first wireless access point to a second wireless access point,
wherein the content presenter is to dynamically modify the features associated with the brand of the provider of the first wireless access point with features associated with a brand of a provider of the second wireless access point.

17. An apparatus comprising:
means for displaying, in a browser window on a client device, features associated with a brand of a provider of a first wireless access point;
means for detecting that the client device has switched from the first wireless access point to a second wireless access point; and
means for dynamically modifying the features associated with the brand of the provider of the first wireless access point with features associated with a brand of a provider of the second wireless access point.

18. A computer readable medium comprising instructions, which when executed on a processing system, cause the processing system to perform a method comprising:
identifying a connection of a client device to a wireless access point; and
causing an appearance of a screen presented on the client device to be modified to reflect a brand associated with a provider of the wireless access point.

19. A computer readable medium comprising instructions, which when executed on a processing system, cause the processing system to perform a method comprising:
displaying, in a browser window on a client device, features associated with a brand of a provider of a first wireless access point;
detecting that the client device has switched from the first wireless access point to a second wireless access point; and
dynamically modifying the features associated with the brand of the provider of the first wireless access point with features associated with a brand of a provider of the second wireless access point.
